(19) United States
(12) Patent Application Publication
(10) Pub. No.: US 2013/0179283 A1
(43) Pub. Date: Jul. 11, 2013

(54) MEDICAL AND ESTATE PLANNING INFORMATION DISTRIBUTION SYSTEM AND METHOD

(71) Applicant: Mark Henry, Scottsdale, AZ (US)

(72) Inventor: Mark Henry, Scottsdale, AZ (US)

(21) Appl. No.: 13/344,133

(22) Filed: Jan. 5, 2012

(51) Int. Cl. G06F 17/00; G06F 3/048; G06Q 30/06

(52) U.S. Cl. 705/26.1; 715/739; 715/221

(57) ABSTRACT

A method of providing medical and estate planning documents comprising: loading at least one form to a server, the at least one form being one of medical forms or estate planning forms; downloading an application to a mobile device, the application configured to communicate with the server; pressing an icon on the mobile device related to the application; and displaying information stored on the at least one form on a display of the mobile device.

### BACKGROUND

Embodiments of this disclosure generally relate to a medical and personal information system, and more particularly, to a system and method which may be used to distribute medical and personal information to designated individuals during an emergency.

A medical emergency can happen at any time. The leading cause of death for people under the age of 44 in America is emergency trauma. In addition, in the United States alone, it is estimated that 98,000 people die yearly from preventable medical errors. In order to improve one's chances of survival during a medical emergency, it is important to provide emergency responders with any information that may describe one's medical needs.

Presently, there are devices, such as jewelry which are bodily worn and have been used to identify persons with known medical conditions in the event of a medical emergency. Several such examples of this would be a bracelet for identifying a rare blood type or a bracelet for identifying a diabetic or person with a rare allergic reaction to bees, snake bites or spiders. Unfortunately, only very limited medical information may be printed on the jewelry.

These jewelry types of devices may further have information, such as a website, or phone number, which may allow for emergency responders to obtain additional information. Unfortunately, in order to access the medical information, the emergency responder must call the phone number or have a device to access the website. Further, a user password is generally required to access the additional medical information. Thus it takes an additional amount of time to access the medical information, time which may adversely affect the treatment of the patient.

Some recent devices allow for medical records stored on microfilm to be worn on jewelry type devices on the body of a wearer. Unfortunately, these types of devices require some type of reading device to see the information stored on the microfilm. Further, the microfilm only provides very limited medical information in the event of an emergency.

Therefore, it would be desirable to provide a system and method that overcomes the above problems.

### SUMMARY

A mobile device has a touch display, at least one processor, and a memory operatively coupled to said processor. The memory stores program instructions that when executed by the processor, causes the processor to: display an icon on said touch display; connect with a user profile stored on a server, the server storing at least one of medical or estate planning documents; and display said at least one of medical or estate planning documents on said touch display.

A method of providing medical and estate planning documents comprising: accessing a website hosting a plurality of forms, the forms being one of medical forms or estate planning forms; entering information in at least one of the forms; loading the at least one of said forms having the information entered to a server related to the website; downloading an application to a mobile device wherein the application is related to the website; syncing the application with a user profile; pressing an icon on the mobile device related to the application; and displaying the information in the at least one of said forms on a display of the mobile device.

A method of providing medical and estate planning documents comprising: loading at least one form to a server, the at least one form being one of medical forms or estate planning forms; downloading an application to a mobile device, the application configured to communicate with the server; pressing an icon on the mobile device related to the application; and displaying information stored on the at least one form on a display of the mobile device.

The features, functions, and advantages may be achieved independently in various embodiments of the disclosure or may be combined in yet other embodiments.

### BRIEF DESCRIPTION OF THE DRAWINGS

Embodiments of the disclosure will become more fully understood from the detailed description and the accompanying drawings, wherein:

FIG. 1 is a simplified functional block diagram of the system of the present invention;

FIG. 2 is front view of a mobile device using the system of FIG. 1; and

FIG. 3 is a flowchart depicting the operation of the system.

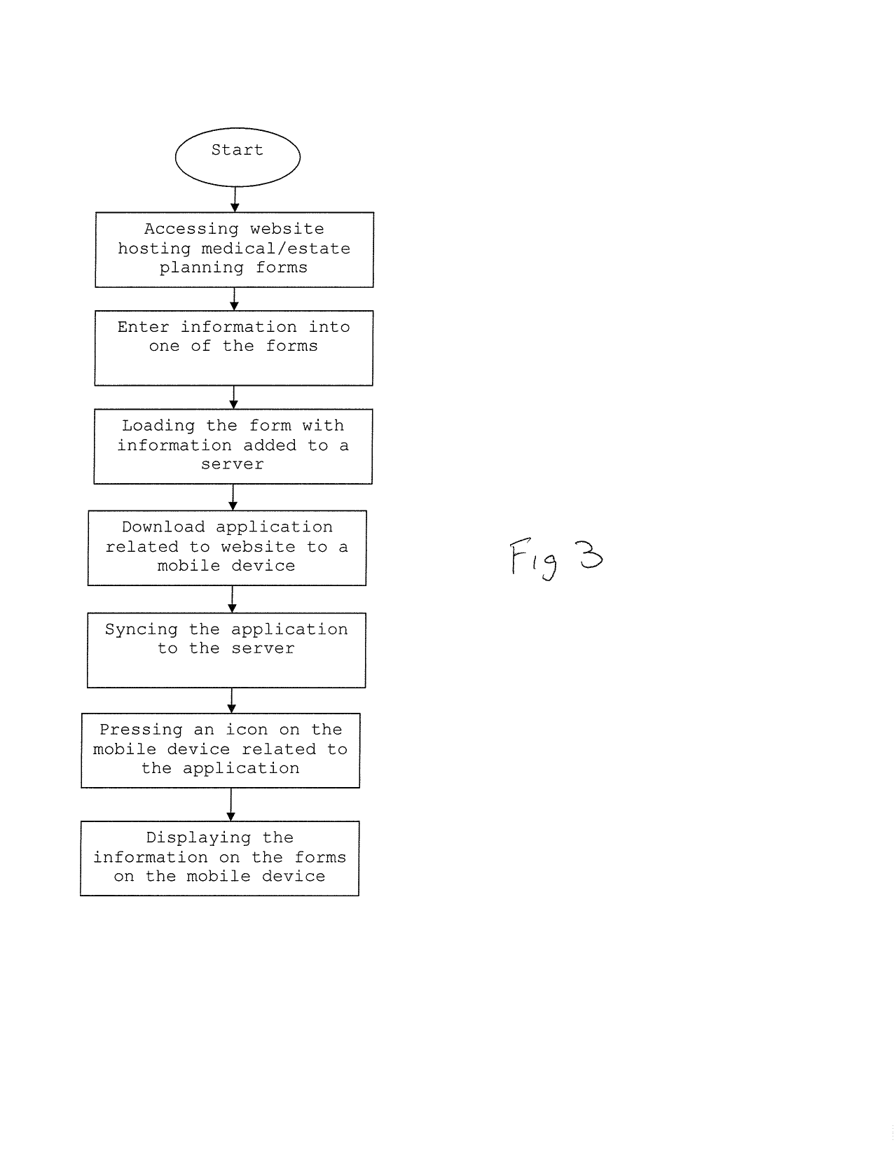

### DETAILED DESCRIPTION

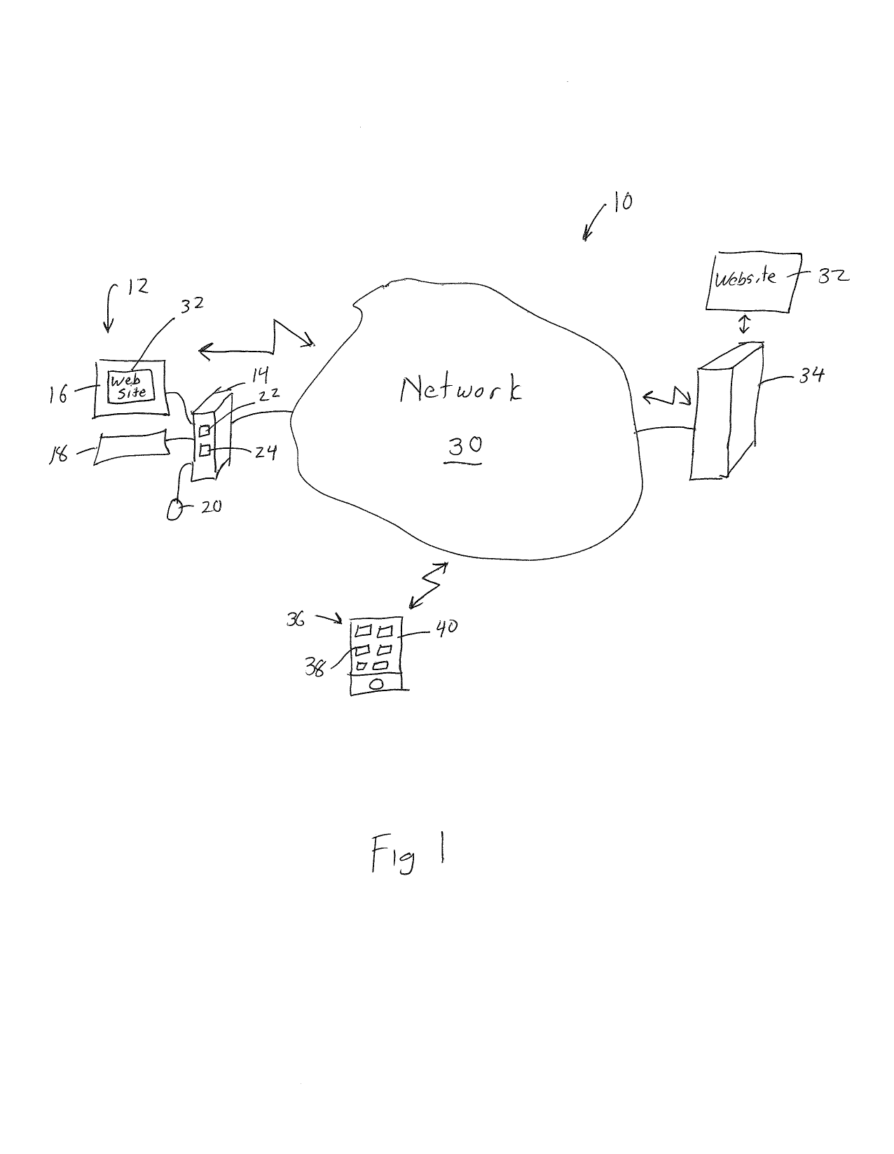

Turning to FIG. 1, a system 10 is shown. The system 10 may be used for the distribution of medical and estate planning information to designated individuals. For example, the system 10 may be used to provide detailed medial information to healthcare providers, family, friends, and the like. The listing of the above is given as an example and should not be seen in a limiting manner. Thus, the above designated individuals may have detailed medical information for a person during a medical emergency thereby improving one's chances of survival during a medical emergency. The system 10 may further provide estate planning information such as but not limited to: wills, trusts, beneficiary designations, powers of appointments, property ownership, powers of attorney, and living wills.

The system 10 may use a computer system 12. The computer system 12 may have a processor unit 14 and a display 16. Input devices may be coupled to the processor unit 14. The input devices may be a keyboard 18, a mouse 20 and the like. Through the execution of program instructions forming a computer program product within the computer system 12, signals coming from or going to a network 30 may be controlled. The network 30 may be a local-area network (LAN), wide-area network (WAN) or the Internet. The computer system 12 may be coupled to the network 30 via a wired connection or a wireless connection.

The program instructions may be located within a memory 22 of the processor unit 14 and executed by a central processing unit 24 (CPU). Any data stored from the running of the program instructions may be stored entirely within a storage media 26 and/or the memory 22.

The computer system 12 may be used to access a website 32 hosted on a server 34. When a user accesses the website 32, the user may be sent to a login/new account screen. In the login/new account screen, the server 34 may establish a sequence to acquire user information after new user enters a user name, password, and other identifying information. If the user is already a member, the server 34 may establish a login sequence where the user may enter the user name and password which may be used to gain access to the website 32.

When a user gains access to the website 32, the user may be provided with a menu which may show different forms which the user may preview. The forms may include a short medical history, including past surgeries or major problems, current medical conditions, current/past doctors and their phone numbers, medications, immunizations, allergies (especially drugs, latex), insurance information, and the like. The listing of forms/information is given as an example and should not be seen in a limiting manner. The forms may further include estate planning forms such as but not limited to: wills, trusts, beneficiary designations, powers of appointments, property ownership, powers of attorney, and living wills. Again, the listing of forms/information is given as an example and should not be seen in a limiting manner.

The user may review any of the forms to see what information may be required. The user may then purchase the selected form(s). The server 34 may establish a purchase sequence where the user may enter credit card information, bank account information, or the like. The listing of the above is given as an example and should not be seen in a limiting manner.

Once a form is purchased, the user may fill out the information in the form. The user may fill-in as much or as little information as the user desires. The user may further include additional information not noted on the form. The form may be filled-in online using existing software such as Adobe Acrobat®, or the like. Alternatively, the form may be printed out and filled in manually. Once the form(s) has been filled-in, the form(s) is/are saved and uploaded to the server 34. If the form(s) are manually filled-in, the forms may be scanned and uploaded to the server 34. The form(s) are then saved under the user's profile which was created on the website 32.

The information placed in the form(s) may be changed and reloaded at any time to the user's profile. The digital form(s) saved under the user's profile may now contain the user's medical and/or estate planning information. In some jurisdictions, a notary and or witness signatures may be required for the form(s) to serve as legally binding documents. Thus, it may be beneficial to print the fill-out form(s), have the filled-out form(s) signed by one or more witnesses and or a notary. The signed fill-out form may then be scanned and uploaded to the server 34.

Under the user's profile in the website 32, the user may identify certain individuals to receive the signed fill-out forms which were uploaded to the server 34 in case of an emergency. The user may need to provide contact information for each individual the user selects. For example, the user may provide email addresses so that the signed fill-out forms may be immediately emailed to the designated individuals in case of an emergency. Other contact information may include a SMS number, fax number, and the like. The listing of the above is given as examples and should not be seen in a limiting manner. Preferably, the contact information for each individual should allow for immediate sending of the signed fill-out forms to the designated individuals.

Once the forms have been purchased, the user may download a medical/estate planning application (hereinafter application) which may be loaded to a cellular phone, tablet, or other like devices (hereinafter cellular phone 36). The listing of the above is given as an example and should not be seen in a limiting manner. The application may be downloaded from the server 34 hosting the website 32, or other servers which may host different mobile applications. The application may be used for the distribution and or displaying of the user's documents uploaded to the server 34.

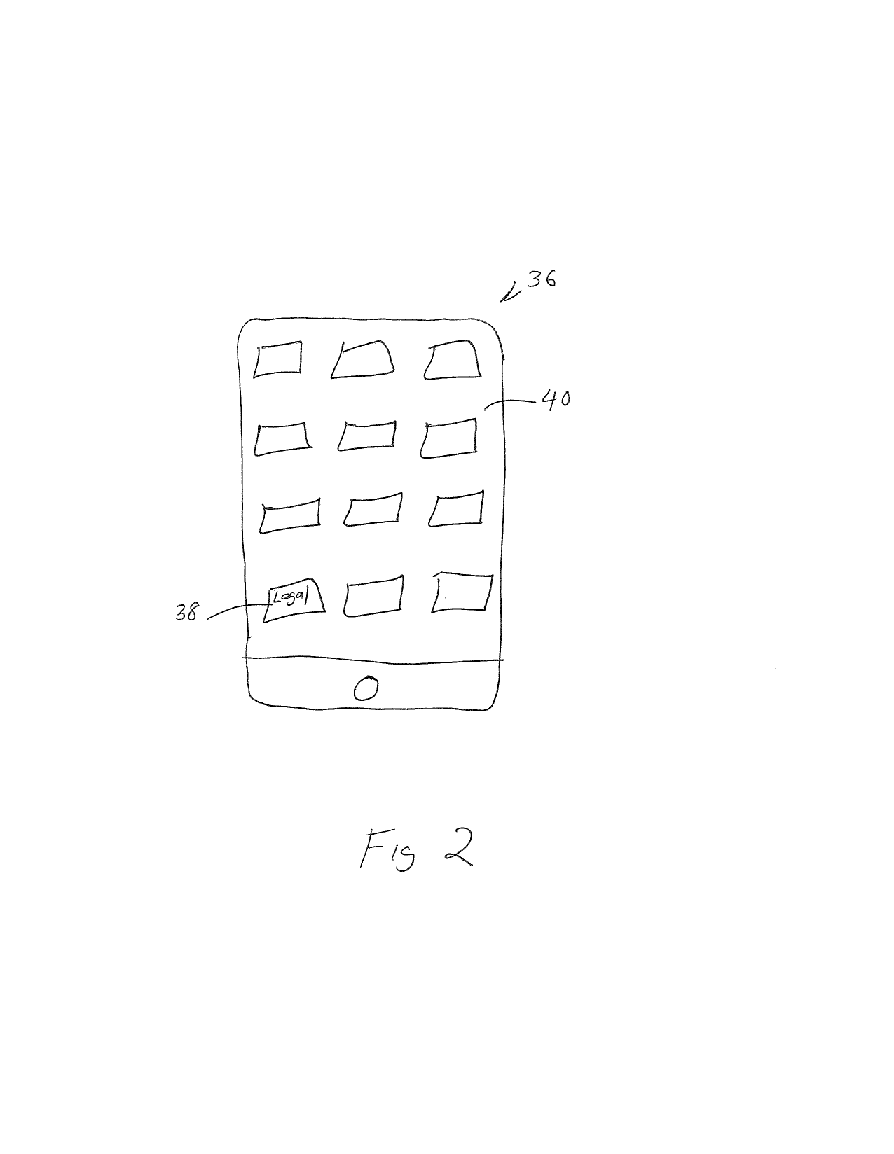

Referring to FIG. 2, the cellular phone 36 may have a processor for implementing logic and memory storing program instructions. The memory can include one or more device managers for interacting with one or more I/O devices. The device managers can be software installed on the cellular phone 36. A device manager can correspond to each I/O device. In addition to the device manager, one or more application programs can be loaded into memory and run on or in association with an operating system on the cellular phone 36.

As shown in FIG. 2, the cellular phone 36 may have an icon 38 related to the application downloaded from the server 34 hosting the website 32. The icon 38 may be displayed on the screen 40 of the cellular phone 36. The screen 40 may be an interactive touch screen 40. By pressing the icon, the user may launch the application downloaded from the server 34. Once the application has been launched, the user may be required to enter the same user name and password which the user used to gain access to the website 32. Entering the same user name and password will activate the application and syncs the user information stored on the server 34 with the cellular phone 36.

The next time the icon is pressed; the information contained under the user's profile may automatically be loaded and reviewed on the cellular phone 36. The user information may be stored the memory of the cellular phone 36. Alternatively, the cellular phone 36 may download the information contained under the user's profile from the server 34. Since the information contained under the user's profile is automatically loaded and reviewable on the cellular phone 36, emergency personnel, hospital staff, caregivers and the like will have immediate access to the user's medical information.

The user's information may also be sent to the individuals the user identified to receive the signed fill-out forms in case of an emergency. As previously stated, the user may need to provide contact information for each individual the user selects. Thus, once the icon is pressed after the user has activated the application, copies of the signed fill-out forms may then be sent to the designated individuals by the designated contact route. For example, if the user identified that Individual 1 should receive copies of the signed fill-out forms by email and Individual 2 by fax, then Individual 1 will receive copies of the signed fill-out forms by email and Individual 2 will receive copies of the signed fill-out forms by fax.

While embodiments of the disclosure have been described in terms of various specific embodiments, those skilled in the art will recognize that the embodiments of the disclosure may be practiced with modifications within the spirit and scope of the claims.

What is claimed is:

1. A mobile device comprising:
a touch display;
at least one processor; and
a memory operatively coupled to said processor, said memory storing program instructions that when executed by said processor, causes said processor to:
display an icon on said touch display;
connect with a user profile stored on a server, the server storing at least one of medical or estate planning documents;
display said at least one of medical or estate planning documents on said touch display.

2. The mobile device of claim 1, wherein said memory storing program instructions, when executed by said processor, causes said processor to:
display a login menu after said icon is first pressed; and
display said at least one of medical or estate planning documents on said touch display after said icon is pressed a second time.

3. The mobile device of claim 1, wherein said memory storing program instructions, when executed by said processor, causes said processor to transfer said at least one of medical or estate planning documents to at last one designated individual.

4. A method of providing medical and estate planning documents comprising:
accessing a website hosting a plurality of forms, said forms being one of medical forms or estate planning forms;
entering information in at least one of said forms;
loading the said at least one of said forms having said information entered to a server related to said website;
downloading an application to a mobile device, said application related to said website;
syncing said application with a user profile;
pressing an icon on said mobile device related to said application; and
displaying said information in said at least one of said forms on a display of said mobile device.

5. The method of claim 4, further comprising transmitting said information in said at least one of said forms to designated individuals.

6. The method of claim 4, further comprising creating a user profile on said website.

7. The method of claim 4, further comprising:
printing said at least one of said forms; and
notarizing said at least one of said forms after entering information in said at least one of said forms.

8. The method of claim 4, further comprising:
reviewing said at least one of said forms; and
purchasing said at least one of said forms prior to entering said information in said at least one of said forms.

9. A method of providing medical and estate planning documents comprising:
loading at least one form to a server, said at least one form being one of medical forms or estate planning forms;
downloading an application to a mobile device, said application configured to communicate with said server;
pressing an icon on said mobile device related to said application; and
displaying information stored on said at least one form on a display of said mobile device.

10. The method of claim 9, further comprising transmitting said information stored on said least one form to designated individuals.

11. The method of claim 9, further comprising creating a user profile on said website.

12. The method of claim 9, further comprising:
printing said at least one of form; and
notarizing said at least one of form after entering information in said at least one of said forms.

13. The method of claim 9, further comprising:
reviewing said at least one of form; and
purchasing said at least one form prior to entering said information in said at least one form.

14. The method of claim 9, further comprising:
accessing a website hosting a plurality of at least one of medical forms or estate planning forms;
registering a user identifications with said website.

15. The method of claim 14, further comprising syncing said mobile device with said website.
